(19) United States
(12) Patent Application Publication
(10) Pub. No.: US 2010/0175060 A1
(43) Pub. Date: Jul. 8, 2010

(54) Simplifying Selection of Targets for Installation of Composite Applications

(75) Inventors: James R. Boykin, Pflugerville, TX (US); Alberto Giammaria, Austin, TX (US)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(73) Assignee: International Business Machines Corporation, Armonk, NY (US)

(21) Appl. No.: 12/349,214

(22) Filed: Jan. 6, 2009

(51) Int. Cl. G06F 9/44

(52) U.S. Cl. 717/173

(57) ABSTRACT

The present invention provides for formulating a deployment plan for a composite application. A set of topologies is provided for each component of a set of identified components of the composite application to be deployed. For a selected topology for each component of the set of identified components, a set of target computing resources are identified that meet, within a predetermined threshold, a set of prerequisites for each component in the set of identified components. A list of hosts associated with the set of target computing resources that meet the identified topology is displayed. For a selected host for each component of the set of identified components, the set of target computing resources for the selected hosts is displayed. A deployment plan along with a set of installations or upgrades required for each of the selected target computing resources is then displayed.

### BACKGROUND

The present application relates generally to an improved data processing apparatus and method and more specifically to an apparatus and method for simplifying selection of targets for installation of composite applications.

A composite application is a distributed application whose components run on two or more computing devices. A good example of a composite application is an application where a user interface server runs on one computing device, a data processing server runs on another computing device, and an authorization server runs on yet another computing device. When an administrator deploys a composite application, the administrator is required to select a topology among all of the topologies supported by the composite application and the computing devices for each component defined by the chosen topology, which may be referred to as targets. The administrator also has to make several considerations in order to identify the correct targets, such as:
What are all the possible topologies supported by the application?
Does the application component need a computing device with a fast central processing unit CPU or a big disk or both?
If the application component needs to connect to a database server, which database server implementations are allowed?
Are there computing devices in a managed environment that have the prerequisites of the composite application installed?

Several tools exist that run prerequisite checks on a machine before installing an application component, but doing so on different machines just to find the most appropriate target is tedious and does not allow an easy comparison between different candidates. Moreover, different models exist for representing applications, the application's components, and the dependencies for each component. Currently, there are no models that exist for composing topologies of a composite application starting from the topologies of the composite application's components and ranking computing devices based on suitability as targets of each application component.

### SUMMARY

In one illustrative embodiment, a method, in a data processing system, is provided for formulating a deployment plan for a composite application. The illustrative embodiments provide a set of topologies for each component of a set of identified components of the composite application to be deployed. For a selected topology for each component of the set of identified components, the illustrative embodiments identify, within a predetermined threshold, a set of target computing resources that meet a set of prerequisites for each component in the set of identified components. The illustrative embodiments display a list of hosts associated with the set of target computing resources that meet the identified topology. For a selected host for each component of the set of identified components, the illustrative embodiments display the set of target computing resources for the selected hosts. The illustrative embodiments display a deployment plan along with a set of installations or upgrades required for each of the selected target computing resources.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an example distributed data processing system in which aspects of the illustrative embodiments may be implemented;

FIG. 2 shows a block diagram of an example data processing system in which aspects of the illustrative embodiments may be implemented;

FIG. 3 is an exemplary block diagram illustrating a composite application deployment system in accordance with an illustrative embodiment;

FIGS. 4A-4E depict examples of various sections of composite application descriptor that may be analyzed by a composite application deployment system in accordance with an illustrative embodiment;

FIG. 5A depicts an exemplary user interface that is displayed to an administrator using a graphical user interface where the administrator may select a topology for each of the identified components in accordance with an illustrative embodiment;

FIG. 5B depicts an exemplary user interface that displays an aggregated topology resulting from the administrator's selections in accordance with an illustrative embodiment;

FIG. 6A depicts an exemplary user interface that is displayed to an administrator using a graphical user interface where the administrator may choose available hosts for the components of the composite application in accordance with an illustrative embodiment;

FIG. 6B depicts an exemplary user interface that may be displayed to an administrator using a graphical user interface where the administrator may select a host for each component of the topology in accordance with an illustrative embodiment;

FIG. 7 depicts an exemplary user interface that may be displayed to an administrator using a graphical user interface summarizing the deployment plan that the user has selected in accordance with an illustrative embodiment; and

FIG. 8 depicts an example of the operation performed by a composite application deployment system in accordance with an illustrative embodiment.

### DETAILED DESCRIPTION

The illustrative embodiments provide a mechanism for simplifying the selection of targets for the installation of composite applications and formulating a deployment plan for the composite application. The illustrative embodiments describe a selection mechanism of topologies and sub-topologies for the components of a composite application and targets for each component of the composite application, allowing easy comparison of the suitability of each target for all the components involved. At the basis of the selection mechanism is a model that analyzes a composite application, the composite application's components, component prerequisites, and allowed topologies for the components.

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, radio frequency (RF), etc.

Computer program code for carrying out operations of the present invention may be written in any combination of one or more programming languages, including an object oriented programming language such as Java™, Smalltalk™, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The illustrative embodiments are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

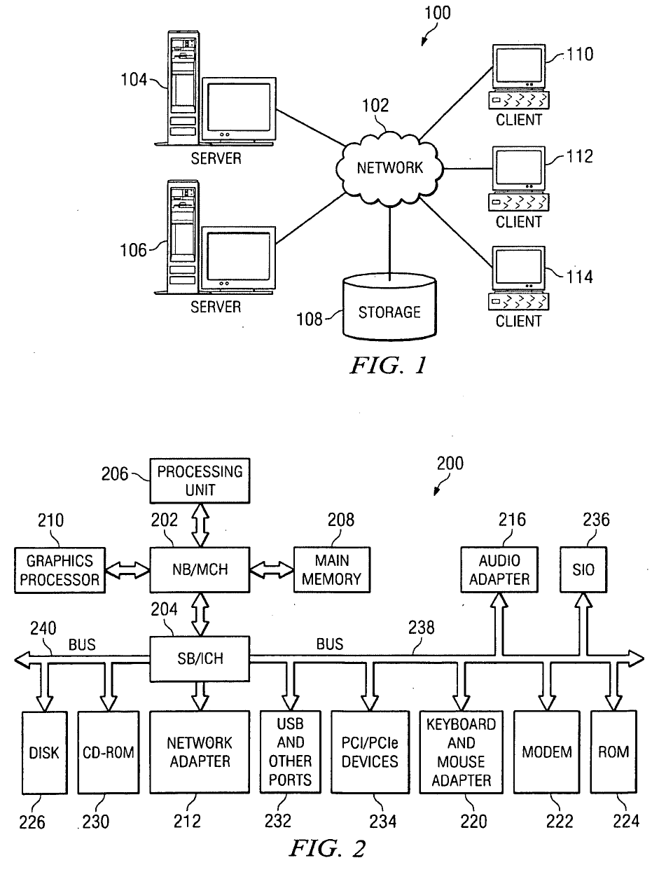

Thus, the illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as example environments in which aspects of the illustrative embodiments may be implemented. While the description following FIGS. 1 and 2 will focus primarily on a single data processing device implementation of a topology, sub-topology, and target selection mechanism, this is only an example and is not intended to state or imply any limitation with regard to the features of the present invention. To the contrary, the illustrative embodiments are intended to include distributed data processing environments and embodiments in which topologies, sub-topologies and targets are selected for the installation of composite applications.

With reference now to the figures and in particular with reference to FIGS. 1-2, example diagrams of data processing environments are provided in which illustrative embodiments of the present invention may be implemented. It should be appreciated that FIGS. 1-2 are only examples and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an example data processing system is shown in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™, System p® computer system, running the Advanced Interactive Executive (AIX®) operating system or the LINUX® operating system (eServer, System p, and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices or computing resources, server computing devices or computing resources, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

As mentioned above, the illustrative embodiments provide a composite application deployment mechanism for simplifying the selection of targets for the installation of composite applications and formulating a deployment plan for the composite application. For a specific composite application, the illustrative embodiments identify the various components of the composite application, minimum requirements for each component, and recommended requirements for each component. The illustrative embodiments then identify a plurality of topologies and sub-topologies for each of the components supported by a composite application. Once the topologies and sub-topologies for the composite application have been identified, then the illustrative embodiments identify targets for each component of the composite application. An administrator or user uses the identified targets to easily compare the suitability of each target for all the components involved.

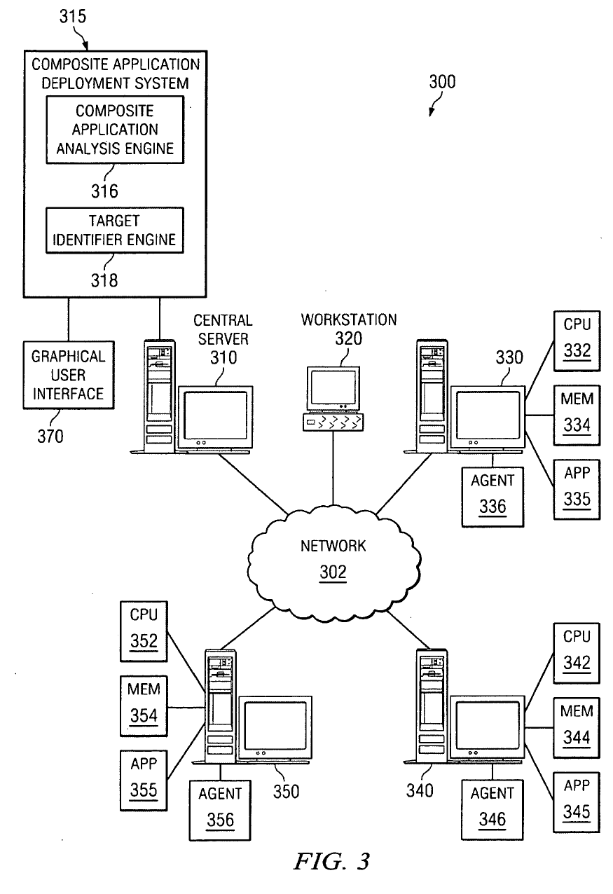

FIG. 3 is an exemplary block diagram illustrating a composite application deployment system in accordance with an illustrative embodiment. As shown in FIG. 3, composite application deployment system 300 comprises central server 310 having composite application deployment system 315 and target identifier engine 318 executing thereon. A system administrator workstation 320 may be coupled through network 302 to central server 310 for deploying and managing composite applications to one or more computing resources 330, 340, and 350 of composite application deployment system 300.

When composite application deployment system 315 receives a composite application from system administrator workstation 320, composite application analysis engine 316 analyzes the descriptor of the composite application to determine specifications of the set of prerequisites associated with the descriptor's components. A component specification may refer to a single component (e.g. WebSphere® Application Server (WAS) connected to single DB2® server), a composite application (e.g. WAS connected to a database cluster) or an interface (e.g. WAS connected to a database system implementing the Java™ Database Connectivity (JDBC™) interface). The interfaces represent the mechanism other components will use to connect to the composite application. Composite application analysis engine 316 also analyzes the descriptors of all known components to resolve each specification (i.e. single components, composite applications, interfaces, or the like) into a matching component. As discussed previously, each of the components of a composite application may be installed on one or more target systems, such as computing resources 330, 340, and 350. In order to decide which of computing resources 330, 340, and 350 that each of the components will be deployed on, composite application analysis engine 316 not only identifies the components but also identifies any dependencies each component has on another component.

After composite application analysis engine 316 identifies the components and component dependencies of the composite applications, composite application analysis engine 316 identifies any topology requirements for the components of the composite application. Each of the components of the composite application may be arranged in different topologies. Topologies are arranged in different computing resources, each computing device comprising one or more of the identified components. However each topology is required to satisfy the interfaces of the components to which the interface belongs. Some of the requirements for the interface topologies may be identified by the composite application. That is, the composite application may include a definition of which components within the composite application may export the interfaces of the components. The interface topology dependency identified by composite application analysis engine 316 represents a dependency on any computing device that implements the required interface for that component.

The composite application analysis engine 316 then analyzes the descriptors of the composite application to identify any prerequisites of the components. Prerequisites of the components may include software and hardware prerequisites such as, the operation system, processor, memory, disk space, or the like of each of the components.

Once the topology requirements and component prerequisites have been identified, composite application deployment system 315 prompts the administrator using graphical user interface 370 to select a topology for each of the identified components if there are multiple topologies identified by composite application analysis engine 316. The administrator may limit the set of matching computing resources specifying that the computing resources and topologies have been certified. Once the administrator identifies a topology for each of the components of the composite application, target identifier engine 318 within composite application deployment system 315 communicates with agent applications on all of the computing resources coupled to network 302 in order to identify target computing resources that meet the prerequisites of the identified components within a predetermined threshold. That is, each of computing resources 330, 340, and 350 have a plurality of targets 332-335, 342-345, and 352-355 as well as agent applications 336, 346, and 356. Agent applications 336, 346, and 356 provide the specification of the targets 332-335, 342-345, and 352-355 and generate data records that are returned to target identifier engine 318. Target identifier engine 318 may aggregate these data records to generate information representative of the specifications, capabilities, and other measures of targets 332-335, 342-345, and 352-355 on computing resources 330, 340, and 350.

Once target identifier engine 318 identifies all of the computing resources that meet the prerequisites of the components within the predetermined threshold, composite application deployment system 315 prompts the administrator using graphical user interface 370 to choose available hosts for the components of the topology. That is, composite application deployment system 315 provides the administrator with a list of all the hosts that have a computing device that meets the prerequisites within the predetermined threshold for each of the identified components. The administrator may then either select a host for each of the components, all of the components or some subset of the components.

Once the administrator indicates that all host selections have been made, composite application deployment system 315 displays using graphical user interface 370 all of the identified targets for the selected hosts that meet the component requirements within the predetermined threshold. Composite application deployment system 315 may display the targets based on their suitability as targets for each of the components of the composite application. By providing a list of each of the targets based on suitability, the administrator may easily compare each of the targets to the requirements for that component of the composite application as well as compare each of the targets to each other. The administrator may also see any hardware or software installations and/or upgrades that may be required to bring each individual target up to the required specification of the desired target.

At this point the administrator may select a target to host each component of the composite application or, if the administrator does not like the results that are provided, the administrator may cancel the current selection of targets and start the selection process over. If the administrator completes a selection of a target for each of the components of the composite application, then composite application deployment system 315 displays using graphical user interface 370 a deployment plan to the administrator. The deployment plan comprises a list of all of the components of the composite application, the selected target for each of the components, and a set of software and or hardware installations and/or upgrades, if any, required for each of the selected targets to meet the component requirements for the components.

Thus, the composite application deployment mechanism simplifies the selection of targets for the installation of composite applications. The various components of the composite application, minimum requirements for each component, and recommended requirements for each component are identified. A plurality of topologies and sub-topologies for each of the components supported by a composite application are also identified. Once the topologies and sub-topologies for the composite application have been identified, one or more targets for each component of the composite application are identified. The administrator may use the identified targets to easily compare the suitability of each target for all the components involved.

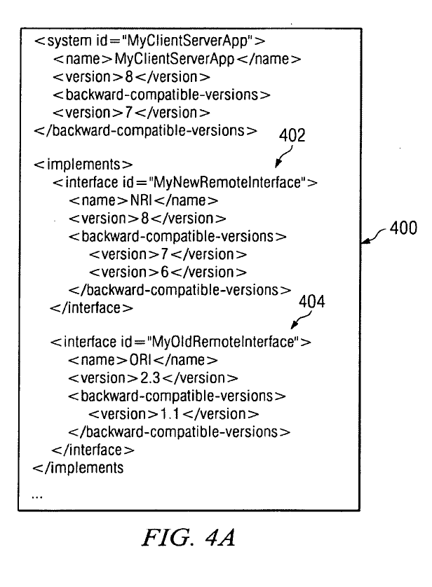

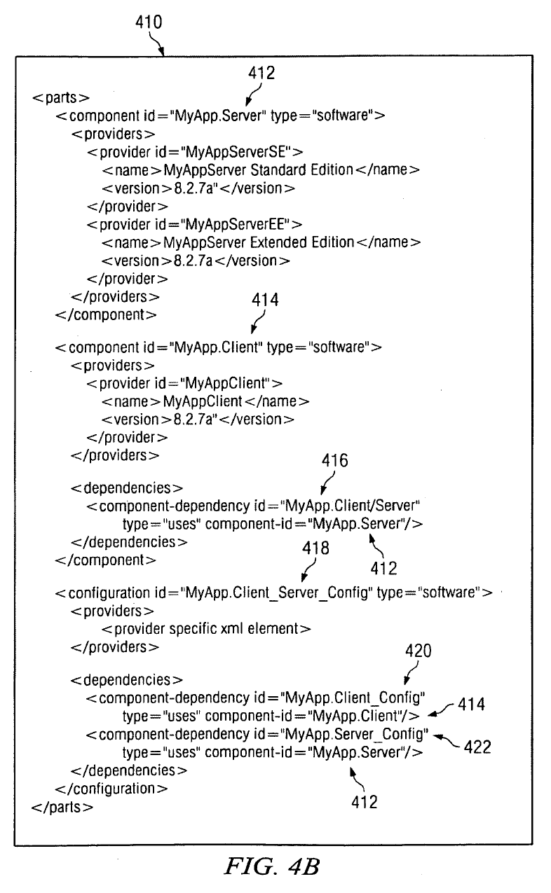

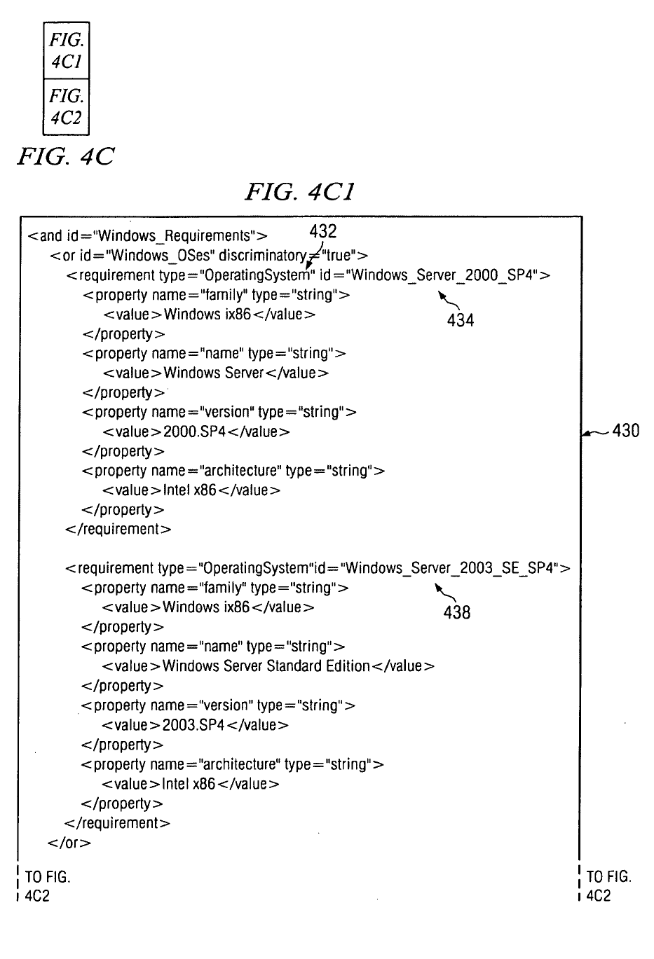

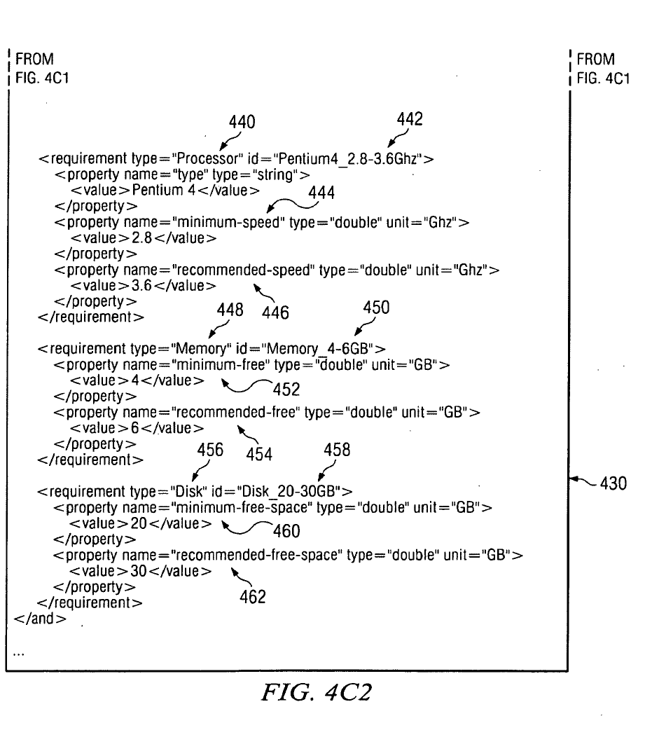

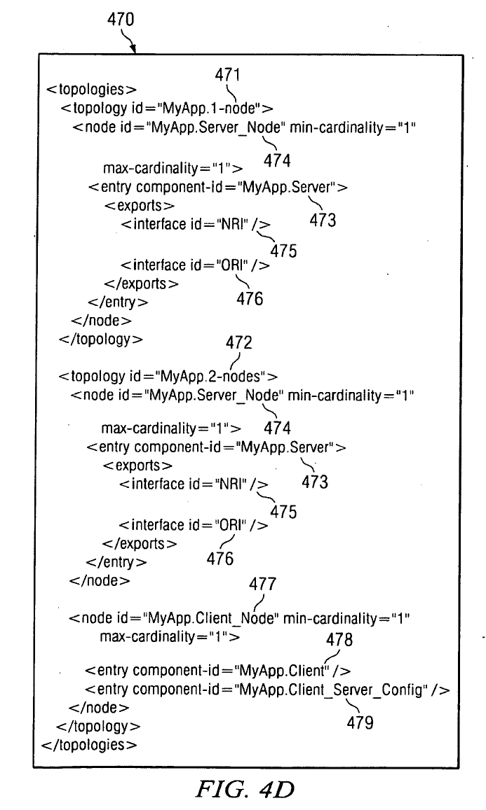

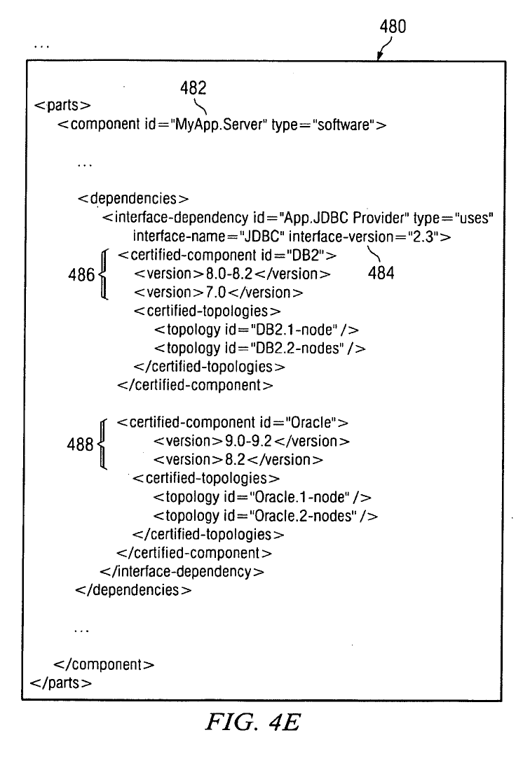

FIGS. 4A-4E depict examples of various sections of composite application descriptor that may be analyzed by a composite application deployment system in accordance with an illustrative embodiment. FIG. 4A depicts descriptor section 400 of a composite application descriptor where interfaces that represent the mechanisms other components will use to connect to the composite application may be identified by a composite application analysis engine. In descriptor section 400, two interfaces are implemented: MyNewRemoteInterface 402 and MyOldRemoteInterface 404.

FIG. 4B depicts descriptor section 410 of a composite application descriptor where the components of the composite application may be identified by the composite application analysis engine. In descriptor section 410, two components are identified: MyApp.Server 412 and MyApp.Client 414. Also in descriptor section 410, there is an identification of a dependency for MyApp.Client 414 illustrated by MyApp.Client/Server 416. As is shown, MyApp.Client_Config 420 is dependent on MyApp.Server 412. Further, descriptor section 41 0 illustrates that MyApp.Client_Server_Config 418 has two dependencies. As is shown, MyApp.Client_Config 420 is dependent on MyApp.Client 414 and MyApp.Server_Config 422 is dependent on MyApp.Server 412.

FIG. 4C depicts descriptor section 430 of a composite application descriptor where requirements for the targets that support the components of the composite application may be identified by the composite application analysis engine. Descriptor section 430 provides requirements for an operation system, processor speed, memory, and disk size. In descriptor section 430, OperatingSystem 432 requirement may either be Windows_Server_{—}2000_SP4 434 or Windows_Server_{—}2003_SE_SP4 438. The requirement for Processor 440 is indicated as Pentium4_{—}2.8-3.6 GHz 442 which is further specified with minimum-speed 444 which indicates a value of 2.8 GHz and a recommended-speed 446 of 3.6 GHz. The requirement for Memory 448 is indicated as Memory_{—}4-6 GB 450 which is further specified with minimum-free 452 which indicates a value of 4 GB and a recommended-free 454 of 6 GB. The requirement for Disk 456 is indicated as Disk_{—}20-30 GB 458 which is further specified with minimum-free-space 460 which indicates a value of 20 GB and a recommended-free-space 462 of 30 GB

FIG. 4D depicts descriptor section 470 of a composite application where requirements for the topology of the components of the composite application may be identified by a composite application analysis engine. In descriptor section 470, a descriptor is shown for two different topologies for MyApp: single node topology “MyApp.1-node” (element 471) and two nodes topology “MyApp.2-nodes” (element 472). In topologies 471 and 472, component “MyApp.Server” (element 473) in node “MyApp.Server_Node” (element 474) exports interfaces 475 and 476 identified as NRI and ORI, respectively. NRI logically references interface 402 and ORI logically references interface 404. Two nodes topology 472 also comprises additional node “MyApp.Client_Node” (element 477) that contains software component “MyApp.Client” (element 478) and configuration component “MyApp.Client_Server_Config” (element 479).

FIG. 4E depicts descriptor section 480 of composite application descriptor where requirements for the MyApp.Server component of the composite application may be identified by a composite application analysis engine. In descriptor section 480, MyApp.Server 482 depends on any component implementing JDBC interface-version 2.3 (element 484). Of all the components implementing JDBC interface 484, only DB2, version 7.0, 8.0-8.2 (element 486), with one or two nodes topologies and Oracle, version 8.2, 9.0-9.2 (element 488), with one or two nodes topologies are certified.

Thus, the composite application analysis engine of the composite application deployment system identifies the components, component dependencies, component prerequisites of the composite applications, and topology requirements for the components of the composite application. Once these elements have been identified, the composite application deployment system may then prompt the administrator to select a topology for each of the identified components.

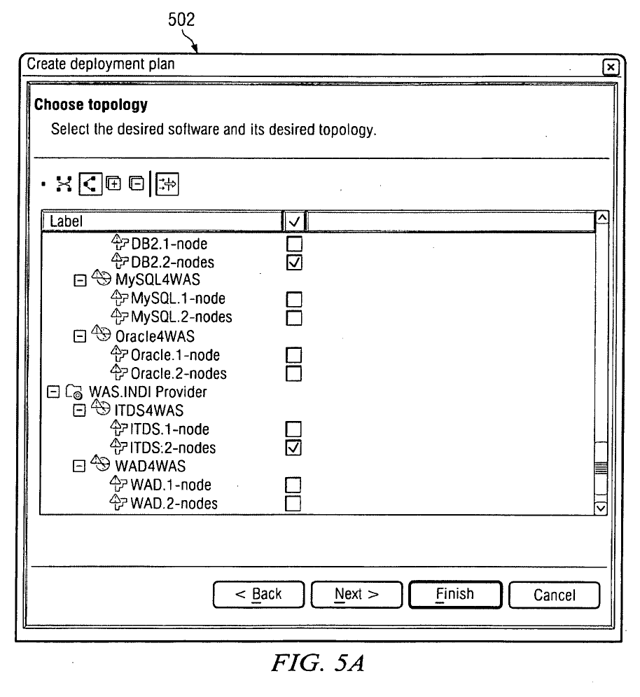

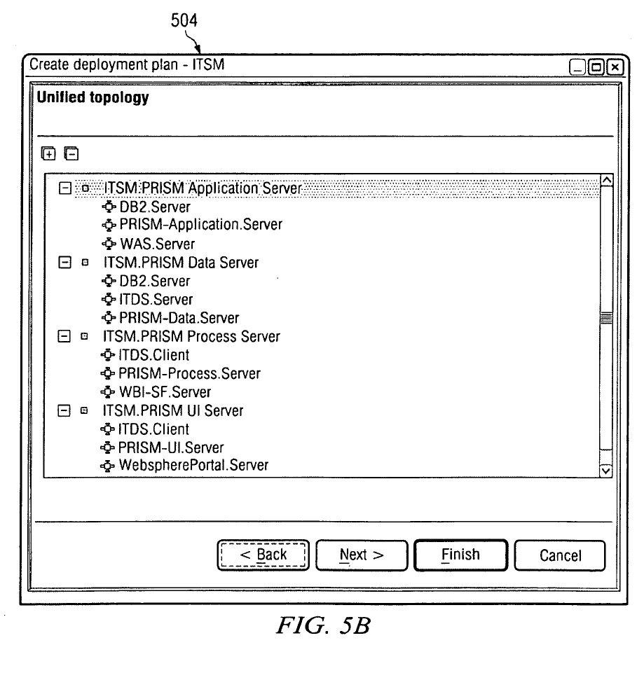

FIG. 5A depicts an exemplary user interface that is displayed to an administrator using a graphical user interface where the administrator may select a topology for each of the identified components in accordance with an illustrative embodiment. As is shown in user interface 502, a list of all the defined topologies that is used by a deployment planning user interface allows an administrator to choose a deployment topology between all the available ones for each of the components. User interface 502 provides for instances where a component supporting multiple topologies may depend on another component supporting multiple topologies. Thus, the administrator is allowed to choose a topology for all the components used by a certain composite application.

FIG. 5B depicts an exemplary user interface that displays an aggregated topology resulting from the administrator's selections in accordance with an illustrative embodiment. As is shown in user interface 504, the user is presented with all the software components and configuration elements that are going to be installed on each logical node.

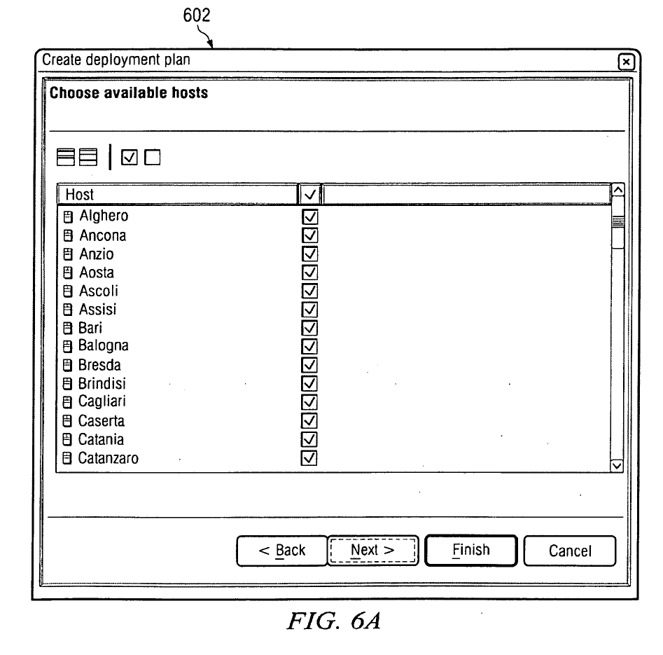

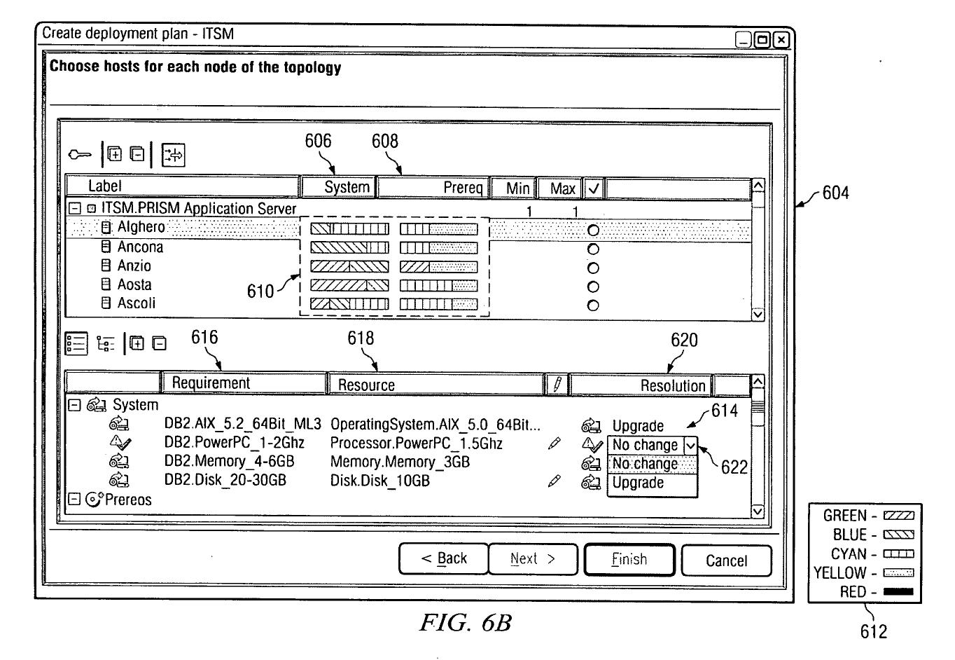

FIG. 6A depicts an exemplary user interface that is displayed to an administrator using a graphical user interface where the administrator may choose available hosts for the components of the composite application in accordance with an illustrative embodiment. In user interface 602, the administrator may either add or select machines that are available for deployment. The administrator may select more machines than the number needed for the deployment of the chosen topology. The composite application deployment system calculates the machines that qualify for each logical node and present them in a ranked order. Once the administrator selects hosts, then the user choose a host for each of the component of the composite application.

FIG. 6B depicts an exemplary user interface that may be displayed to an administrator using a graphical user interface where the administrator may select a host for each component of the topology in accordance with an illustrative embodiment. User interface 604 shows the machines that qualify for each logical node presented in ranking order. System column 606 provides an indication of the system requirements, such as Operating System, Processor, Memory, Disk, or the like, that are satisfied, while Prereq column 608 provides an indication of the software prerequisites that are satisfied. Bars 610, which are indicated with different fill patterns for illustration but may be multicolored in presentation to the administrator, are built considering how many system requirements or software prerequisites are satisfied. Different fill patterns with associated colors, which are shown in legend 612, are associated to the results of the system requirements and software prerequisites for each host, for example:
Recommended requirement satisfied (green)
Minimum requirement satisfied (blue)
Upgrade required (cyan)
Install required (yellow)
Failure (red)
   The administrator may then select the machine(s) intended for use for each component. Once the administrator selects a machine intended for use for each component, the administrator is presented with list 614 that indicates requirements 616 for the composite application and resources 618 for the selected machine. For each requirement of the composite application, resolution 620 indicates the necessary resolution to bring the resource up to the minimum requirement. If the particular resource is available but is below the minimum requirement, then resolution 620 will indicate “Upgrade” for the resource. If the particular resource is non-existent in the selected machine, then resolution 620 will indicate “Install” for the resource. If the particular resource is available and is at the recommended requirements, then resolution 620 will indicate “No Change” for the resource. If the particular resource is available and is within the range of the requirements but not at the recommended requirements, then resolution 620 will indicate “No Change” for the resource. However, if the case occurs, the administrator is presented with an option as is indicated by drop down window 622 where the administrator may change the indicated “No Change” to “Upgrade” so that the resource will be upgraded to the recommended requirements. Once the administrator completes the available selection(s) for each of the components of the composite application, then the composite application deployment system presents the administrator with a summary of the deployment plan that the user has selected.

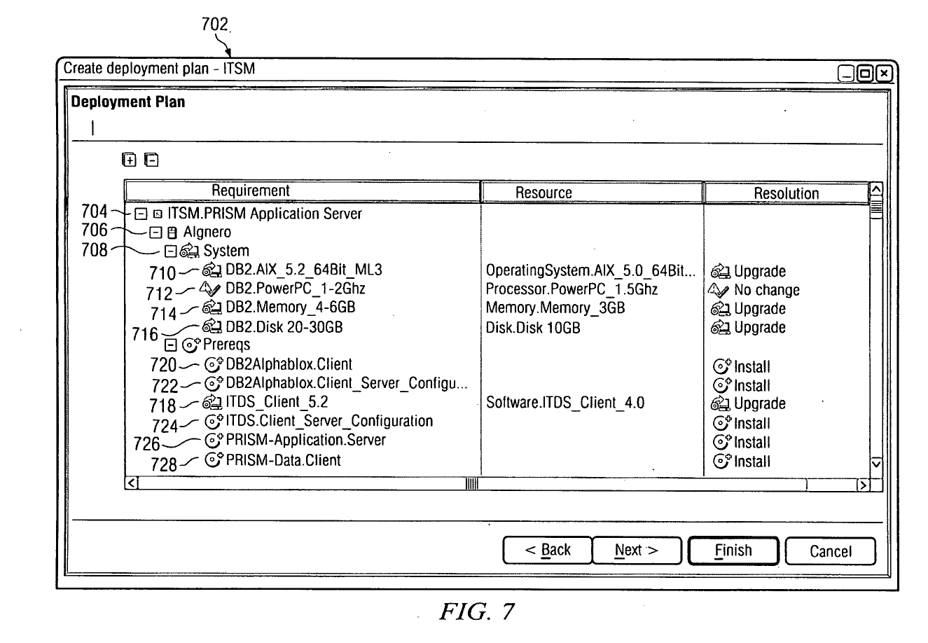

FIG. 7 depicts an exemplary user interface that may be displayed to an administrator using a graphical user interface summarizing the deployment plan that the user has selected in accordance with an illustrative embodiment. In user interface 702, the deployment plan illustrates that ITSM.PRISM application server 704 will be deployed on host Alghero 706. Also illustrated in user interface 702 is that for system 708, Operating System 710, memory 714, and Disk 716 will require upgrades, while processor 712 will not require any change. Further, the software of ITSM.PRISM application server 704 will require that ITDS_Client_{—}5.2 718 will also be upgraded. In user interface 702, the deployment plan also indicates multiple components will require installation. That is, ITSM.PRISM application server 704 will require the installation of DB2Alphablox.Client 720, DB2Alphablox.Client_Server_Configuration 722, ITDS.Client_Server_Configuration 724, PRISM-Application.Server 726, and PRISM-Data.Client 728. While FIG. 7 depicts many software and hardware installations and upgrades, the illustrative embodiments are not limited to the illustrated types of upgrades and installations. That is, other upgrades and/or installations may be made without departing from the spirit and scope of the present invention.

Thus, the composite application deployment mechanism simplifies the selection of targets for the installation of composite applications. Once the descriptor of the composite application is analyzed to identify various components of the composite application, minimum requirements for each component, recommended requirements for each component, and a plurality of topologies and sub-topologies for each of the components supported by a composite application, the administrator is then able to use a set of identified targets to easily compare the suitability of each target for all the components involved and to select targets for each of the components of the composite application.

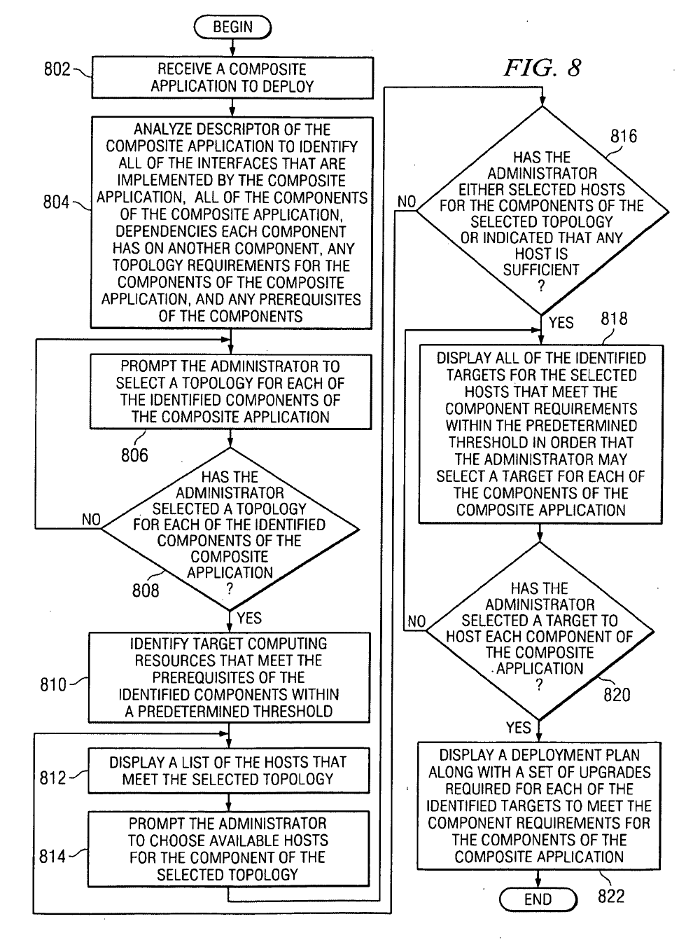

FIG. 8 depicts an example of the operation performed by a composite application deployment system in accordance with an illustrative embodiment. As the operation begins, the composite application deployment system receives a composite application to deploy (step 802). The composite application deployment system analyzes the descriptor of the composite application to determine all of the interfaces that are implemented by the composite application, all of the components of the composite application, dependencies each component has on another component, any topology requirements for the components of the composite application, and any prerequisites of the components (step 804).

The composite application deployment system then prompts the administrator to select a topology for each of the identified components of the composite application if there are multiple topology choices for the identified component (step 806). The composite application deployment system determines if the administrator has selected a topology for each of the identified components of the composite application (step 808). If at step 808 the administrator has not selected a topology for each of the identified components of the composite application, then the operation returns to step 806. If at step 808 the administrator has selected a topology for each of the identified components of the composite application, then the composite application deployment system identifies target computing resources that meet the prerequisites of the identified components within a predetermined threshold (step 810).

Once the composite application deployment system identifies all of the computing resources that meet the prerequisites of the components within the predetermined threshold, the composite application deployment system displays a list of the hosts that meet the selected topology (step 812). The composite application deployment system then prompts the administrator to choose available hosts for the component of the selected topology (step 814). The composite application deployment system determines if the administrator has either selected hosts for the components of the selected topology or indicated that any host is sufficient (step 816). If at step 816, the administrator has failed to select hosts for the components of the selected topology or failed indicating that any host is sufficient, the operation returns to step 812.

If at step 816 the administrator has selected hosts for the components of the selected topology or indicated that any host is sufficient, the composite application deployment system displays all of the identified targets for the selected hosts that meet the component requirements within the predetermined threshold in order that the administrator may select a target for each of the components of the composite application (step 818). The composite application deployment system may display the targets based on their suitability as a target for each of the components of the composite application. The composite application deployment system then determines if the administrator has selected a target to host each component of the composite application (step 820). If at step 820 the administrator has not selected a target for each component of the composite application, then the operation returns to step 818. If at step 820 the administrator completes a selection of a target for each of the components of the composite application, then the composite application deployment system displays to the administrator a deployment plan along with a set of installations and/or upgrades required for each of the identified targets to meet the component requirements for the components of the composite application (step 822), with the operation ending thereafter. The deployment plan comprises a list of all of the components of the composite application, the selected target for each of the components, and a set of installations and/or upgrades, if any, required for each of the selected targets to meet the component requirements for the components.

Thus, the illustrative embodiments provide a mechanism for formulating a deployment plan of a composite application. The composite application deployment mechanism simplifies the selection of targets for the installation of composite applications. For a specific component application, the illustrative embodiments identify the various components of the composite application, minimum requirements for each component, and recommended requirements for each component. The illustrative embodiments then identify a plurality of topologies and sub-topologies for each of the components supported by a composite application. Once the topologies and sub-topologies for the composite application have been identified, then the illustrative embodiments identify targets for each component of the composite application. An administrator or user uses the identified targets to easily compare the suitability of each target for all the components involved.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for formulating a deployment plan for a composite application, the method comprising:
providing a set of topologies for each component of a set of identified components of the composite application to be deployed;
for a selected topology for each component of the set of identified components, identifying, within a predetermined threshold, a set of target computing resources that meet a set of prerequisites for each component in the set of identified components;
displaying a list of hosts associated with the set of target computing resources that meet the identified topology;
for a selected host for each component of the set of identified components, displaying the set of target computing resources for the selected hosts; and
displaying a deployment plan along with a set of installations or upgrades required for each of the selected target computing resources.

2. The method of claim 1, wherein the set of topologies are identified by analyzing a descriptor of the composite application.

3. The method of claim 1, wherein the set of prerequisites for each component in the set of components is identified by analyzing a descriptor of the composite application.

4. The method of claim 1, wherein the deployment plan comprises the set of components of the composite application, the selected target for each component in the set of components, and a set of installations or upgrades for each of the selected target computing device to meet the set of prerequisites for the component with which the selected target computing device is associated.

5. The method of claim 1, wherein displaying the set of target computing resources for the selected hosts is based on a suitability of each target computing device in the set of target computing resources to meet the set of prerequisites for each component of the set of components of the composite application.

6. The method of claim 1, wherein the set of prerequisites for each component in the set of identified components identifies the component as at least one of a single component, a composite application, or an interface.

7. The method of claim 6, wherein the interface represents a mechanism other components in the set of components use to connect to the composite application.

8. The method of claim 1, wherein the set of target computing resources for the selected hosts are limited based on certified target computing resources and certified topologies that are identified by a descriptor of the composite application.

9. The method of claim 1, further comprising:
in addition to receiving the selection of the target computing resource from the set of target computing resources for each component of the set of identified components, receiving a set of upgrade selections from the administrator, wherein the set of upgrade selections indicate that one or more target computing resources of the set of target computing resources is to be upgraded with at least one of additional hardware or additional software and wherein the set of upgrade selections is in addition to the one or more target computing resources meeting the set of prerequisites required for the set of target computing resources.

10. A computer program product comprising a computer recordable medium having a computer readable program recorded thereon, wherein the computer readable program, when executed on a computing device, causes the computing device to:
provide a set of topologies for each component of a set of identified components of the composite application to be deployed;
for a selected topology for each component of the set of identified components, identify, within a predetermined threshold, a set of target computing resources that meet a set of prerequisites for each component in the set of identified components;
display a list of hosts associated with the set of target computing resources that meet the identified topology;
for a selected host for each component of the set of identified components, display the set of target computing resources for the selected hosts; and
display a deployment plan along with a set of installations or upgrades required for each of the selected target computing resources.

11. The computer program product of claim 10, wherein the set of topologies are identified by the computer readable program causing the computing device to analyze a descriptor of the composite application.

12. The computer program product of claim 10, wherein the set of prerequisites for each component in the set of components is identified by the computer readable program causing the computing device to analyze a descriptor of the composite application.

13. The computer program product of claim 10, wherein the deployment plan comprises the set of components of the composite application, the selected target for each component in the set of components, and a set of installations or upgrades for each of the selected target computing device to meet the set of prerequisites for the component with which the selected target computing device is associated.

14. The computer program product of claim 10, wherein displaying the set of target computing resources for the selected hosts is based on a suitability of each target computing device in the set of target computing resources to meet the set of prerequisites for each component of the set of components of the composite application.

15. The computer program product of claim 10, wherein the set of prerequisites for each component in the set of identified components identifies the component as at least one of a single component, a composite application, or an interface.

16. An apparatus, comprising:
a processor; and
a memory coupled to the processor, wherein the memory comprises instructions which, when executed by the processor, cause the processor to:
provide a set of topologies for each component of a set of identified components of the composite application to be deployed;
for a selected topology for each component of the set of identified components, identify, within a predetermined threshold, a set of target computing resources that meet a set of prerequisites for each component in the set of identified components;
display a list of hosts associated with the set of target computing resources that meet the identified topology;
for a selected host for each component of the set of identified components, display the set of target computing resources for the selected hosts; and
display a deployment plan along with a set of installations or upgrades required for each of the selected target computing resources.

17. The apparatus of claim 16, wherein the set of topologies are identified by the instructions causing the processor to analyze a descriptor of the composite application.

18. The apparatus of claim 16, wherein the set of prerequisites for each component in the set of components is identified by the instructions causing the processor to analyze a descriptor of the composite application.

19. The apparatus of claim 16, wherein the deployment plan comprises the set of components of the composite application, the selected target for each component in the set of components, and a set of installations or upgrades for each of the selected target computing device to meet the set of prerequisites for the component with which the selected target computing device is associated.

20. The apparatus of claim 16, wherein displaying the set of target computing resources for the selected hosts is based on a suitability of each target computing device in the set of target computing resources to meet the set of prerequisites for each component of the set of components of the composite application.
